(19) United States
(12) Patent Application Publication
(10) Pub. No.: US 2023/0166600 A1
(43) Pub. Date: Jun. 1, 2023

(54) OPERATING METHOD, CONTROL UNIT FOR A VEHICLE DRIVABLE BY MUSCLE POWER AND ADDITIONALLY BY MOTOR POWER, AND VEHICLE

(71) Applicant: Robert Bosch GmbH, Stuttgart (DE)

(72) Inventors: Daniel Baumgaertner, Tuebingen (DE); Merlin Martin Manewald, Reutlingen (DE)

(21) Appl. No.: 18/058,963

(22) Filed: Nov. 28, 2022

(30) Foreign Application Priority Data
Nov. 30, 2021 (DE) 10 2021 213 463.7

(51) Int. Cl. B60L 3/00; B60L 15/20; B62M 6/50

(52) U.S. Cl. CPC B60L 3/0015; B60L 15/20; B62M 6/50; B60L 2250/00

(57) ABSTRACT

An operating method for a motor drive of a vehicle drivable by muscle power and additionally by motor power, and, in particular, for an electric bicycle, an e-bike, a pedelec, an S-pedelec and the like. The method includes the steps: (i) ascertaining whether and/or in what way an obstacle on a driving route of the vehicle is present directly at the vehicle; (ii) conditionally adapting an operating state of the motor drive as a function of a result of the ascertainment; and (iii) driving the vehicle with the aid of the motor drive in the adapted operating state, as well as to a corresponding control unit and to a vehicle per se.

### CROSS REFERENCE

The present application claims the benefit under 35 U.S.C. 119 of German Patent Application No. DE 10 2021 213 463.7 filed on Nov. 30, 2021, which is expressly incorporated herein by reference in its entirety.

### FIELD

The present invention relates to an operating method and to a control unit for a vehicle drivable by muscle power and additionally by motor power, as well as to a corresponding vehicle.

### BACKGROUND INFORMATION

In conventional vehicles drivable by muscle power and additionally by motor power, the support by the motor drive is controlled or regulated at the most based on measured values with respect to torque, rotational speed and/or uphill grade of the terrain. Obstacles occurring on the course which are to be overcome are not taken into consideration in the process in the operating method of the motor drive.

### SUMMARY

An operating method according to the present invention for a motor drive of a vehicle drivable by muscle power and additionally by motor power may have the advantage over the related art that obstacles occurring on the course may be overcome, by comparison, in a simpler and safer way. This is achieved according to the present invention in that an operating method for a motor drive of a vehicle drivable by muscle power and additionally by motor power, and, in particular, for an electric bicycle, an e-bike, a pedelec, an S-pedelec and the like, is provided. According to an example embodiment of the present invention, the method includes at least the steps:
ascertaining whether and/or in what way an obstacle on a driving route of the vehicle is present directly at the vehicle;
conditionally adapting an operating state of the motor drive as a function of a result of the ascertainment; and
driving the vehicle with the aid of the motor drive in the adapted operating state.

In this way, by adapting the support by the motor drive as a function of the obstacle, a potential obstacle on the course may be overcome more easily and more safely than in the conventional case.

Preferred refinements of the present invention are disclosed herein.

In one preferred specific embodiment of the operating method according to the present invention, the presence of an obstacle is recognized during the ascertainment with respect to a potential obstacle when:
(i) a raising or lift-off of a front wheel of the vehicle, in particular, via an acceleration signal regarding a vertical acceleration;
(ii) a strong pulling on a handle bar grip of the vehicle;
(iii) a rapid change of the position of the vehicle, in particular, from a position in the plane or horizontal into an oblique position;
(iv) a deflection of a spring travel of a damper and/or a suspension fork;
(v) a change in a tire pressure, e.g., via a tire pressure sensor;
(vi) a change in a front wheel velocity, if the front wheel impacts an obstacle during the advance
   is or are detected.

In this connection, it may furthermore be of advantage when, the presence of an obstacle is recognized during the ascertainment with respect to a potential obstacle, when additionally:
(vii) a strong negative velocity gradient at the rear wheel, in particular via a rotational speed sensor at the rear wheel, and/or
(viii) one or multiple hard deflections in an inertial sensor system
   is or are detected.

In another alternative or additional embodiment of the operating method according to the present invention, the following takes place or take place during the conditional adaptation of the operating state of the motor drive:
(a) an increase in the motor torque, i.e., a torque of the motor drive;
(b) an increase in a support factor as a ratio of a torque of the motor drive to a torque introduced by the rider with the aid of muscle;
(c) an extension of a time period of post-acceleration of the motor drive after pedaling by the rider has ended; and/or
(d) a definition of threshold values for a directly permissible velocity decrease and/or rotational speed decrease or their gradients.

In another advantageous exemplary embodiment of the operating method according to the present invention, the activation is adapted, set and implemented during the conditional adaptation of the operating state of the motor drive, in such a way that a velocity of the vehicle and/or a rotational speed of a rear wheel of the vehicle does or do not drop abruptly when the rear wheel hits an obstacle.

As an alternative or in addition, it is of advantage when, according to another refinement of the operating method according to the present invention, during the conditional adaptation of the operating state of the motor drive, an adapted activation of the motor drive and the support of the rider are designed to be greater the higher a detected raising or lift-off of a front wheel of the vehicle is and/or the greater a detected change in position of the vehicle is.

Furthermore, in addition or as an alternative, it is possible that a driving of the vehicle with the aid of the motor drive in the adapted operating state takes place directly, temporally directly and/or without time delay after the presence of an obstacle has been recognized.

On the other hand, it is also possible to carry out a driving of the vehicle with the aid of the motor drive in the adapted operating state with a time delay after the presence of an obstacle has been recognized, the time delay, in particular,
(A) as a function of a velocity of the velocity and/or of a rotational speed of a wheel of the vehicle and/or
(B) being set in such a way that, for its process,
   (B1) a front wheel of the vehicle sits on the obstacle;
   (B2) the front wheel of the vehicle has overcome the obstacle; and/or
   (B3) a rear wheel of the vehicle has reached the obstacle.

The present invention furthermore relates to a control unit for a motor drive of a vehicle drivable by muscle power and additionally by motor power and, in particular, for an electric bicycle, an e-bike, a pedelec, an S-pedelec and the like, which is configured to and includes skills to carrying out, prompt and/or control or regulate an operating method according to the present invention for a motor drive of a vehicle drivable by muscle power and additionally by motor power.

The present invention furthermore relates to a vehicle per se, drivable by muscle power and additionally by motor power, and, in particular to an electric bicycle, an e-bike, a pedelec, an S-pedelec and the like, which is designed with at least one wheel, with a motor drive for driving the at least one wheel, and with a control unit, configured according to the present invention, for controlling the motor drive.

### BRIEF DESCRIPTION OF THE DRAWINGS

With reference to the figures, specific embodiments of the present invention are described in greater detail.

FIG. 1 shows a schematic illustration of one example of a vehicle according to the present invention in the manner of an electric bicycle, in which a first specific embodiment of the present invention is implemented.

FIGS. 2A through 4B illustrate aspects of the operating method according to the present invention based on schematic course sketches and graphs on sensor measured values.

FIG. 5 shows a schematic illustration of another example of a vehicle according to the present invention in the manner of an electric bicycle, with a focus on the implementation of the operating method according to the present invention.

### DETAILED DESCRIPTION OF EXAMPLE EMBODIMENTS

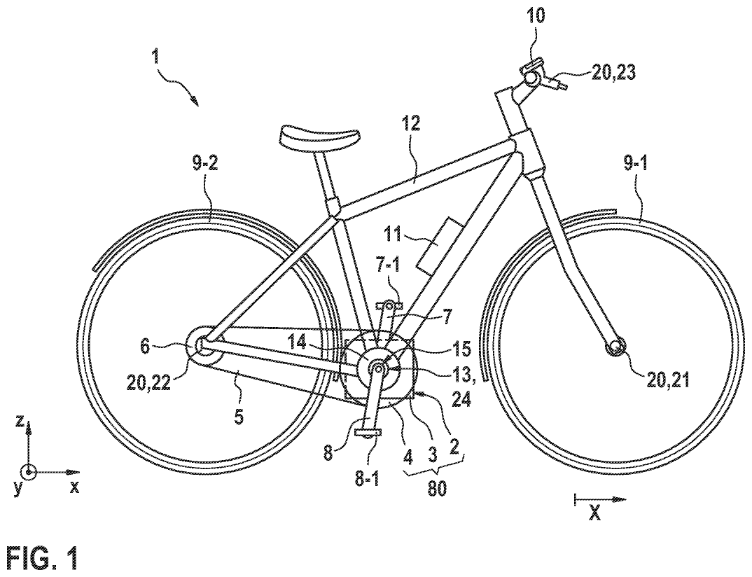

With reference to FIGS. 1 through 5, exemplary embodiments of the present invention and the technical background are described hereafter in greater detail. Identical and equivalent as well as identically or equivalently acting elements and components are denoted by the same reference numerals. The detailed description of the denoted elements and components is not provided each time they occur.

The shown features and further properties may be arbitrarily separated from one another and arbitrarily combined with one another, without departing from the core of the present invention.

FIG. 1 initially shows, in very general terms, a schematic illustration of one example of a vehicle 1 according to the present invention in the manner of an electric bicycle 1, in which a first specific embodiment of the present invention is implemented.

Being an electric bicycle, vehicle 1 includes a frame 12 at which a front wheel 9-1, a rear wheel 9-2 and a crank mechanism 2 including two cranks 7, 8 having pedals 7-1 and 8-1 are situated. An electric drive 3, which may also be referred to as a motor drive and/or as an electric motor, is integrated into crank mechanism 2. A gearshift 6 is situated at rear wheel 9-2.

A drive torque, which is provided by the rider and/or by electric drive 3, is transferred from a chain ring 4 as an output element at crank mechanism 2 via a chain 5 to a pinion of gearshift 6.

Furthermore, a control unit 10, which is connected to electric drive 3, is situated on the handle bar of vehicle 1. Furthermore, battery 11, which is used to supply electric drive 3 with power, is designed in or at frame 12.

Furthermore, a crank bearing 13 or bottom bracket bearing, which includes a crankcase 14 and a crankshaft 15, is integrated into frame 12.

Crank mechanism 2 including crankshaft 15, cranks 7, 8 and pedals 7-1, 8-1 and motor drive 3 are components of a higher-level drive unit 80 of vehicle 1.

For the new control and/or regulation of motor drive 3, a sensor system 20 including, possibly different, sensors 21 through 24 is advantageously designed for detecting the measured values.

Sensors 21 and 22 are formed at front wheel 9-1 or at rear wheel 9-2 and may, for example, measure the respective wheel speed.

Sensor 23 is attached at the handle bar and may, for example, detect the velocity of vehicle 1, the inclination of vehicle 1 or, generally speaking, its position and/or orientation in the space, a vertical acceleration of vehicle 1 and/or a pulling force and/or a pressure force which a rider exerts on the handle bar.

Sensor 24 is attached in the area of the drive unit and may be designed as a gyro sensor and, for example, may recognize the raising of the front wheel and/or recognize a pitching.

As an alternative or in addition, a rotational speed of crankshaft 15, of muscle drive and/or of motor drive 3 may be measured in each case.

A detection of an inclination and/or a detection of a position of a pedal axis is/are also possible.

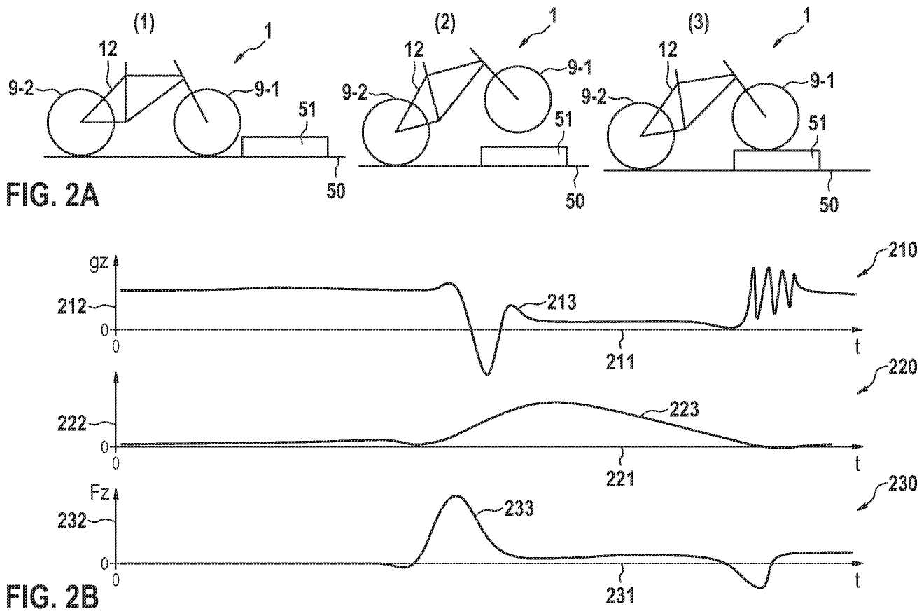

FIGS. 2A through 4B illustrate aspects of the operating method according to the present invention based on schematic course sketches of FIGS. 2A, 3A and 4A situations or states (1) through (5) of vehicle 1 on course 50 or on driving route 50 including possibly present obstacles 51, and in FIGS. 2B, 3B and 4B, based on graphs 201, 202, 230, 310, 320 and 410, among others, of measured values for sensors and the like.

Time t is plotted on x-axes 211, 221, 231, 311, 321 and 411 of graphs 201, 202, 230, 310, 320 and 410.

In this respect, states or situations (1) through (5) of vehicle 1 on course 50 correspond to corresponding points in time t in the profile of graphs 201, 202, 230, 310, 320 and

At y-axes 212 and 312 of graphs 210 and 310, the value of vertical component gz of the acceleration of vehicle 1 at front wheel 9-1 is schematically plotted as a function of time t, i.e., in particular, in each case an acceleration in the z direction and/or perpendicular to the ground.

At y-axes 222 and 322 of graphs 220 and 320, the value of a rotation rate is schematically [plotted] and, in its temporal profile, is representative of a pitching of vehicle 1 as a function of time t.

At y-axis 232 of graph 230, the value of vertical component Fz of a force applied by the rider on the handle bar of vehicle 1 is schematically plotted as a pulling or pressure force. This, for example, describes the upward pulling of front wheel 9-1 in front of or at obstacle 51, and the setting down of front wheel 9-1 on or behind obstacle 51.

Tracks 213, 223, 233, 313, 323, 413 and 414 each schematically describe the temporal profiles of the respective measured variables.

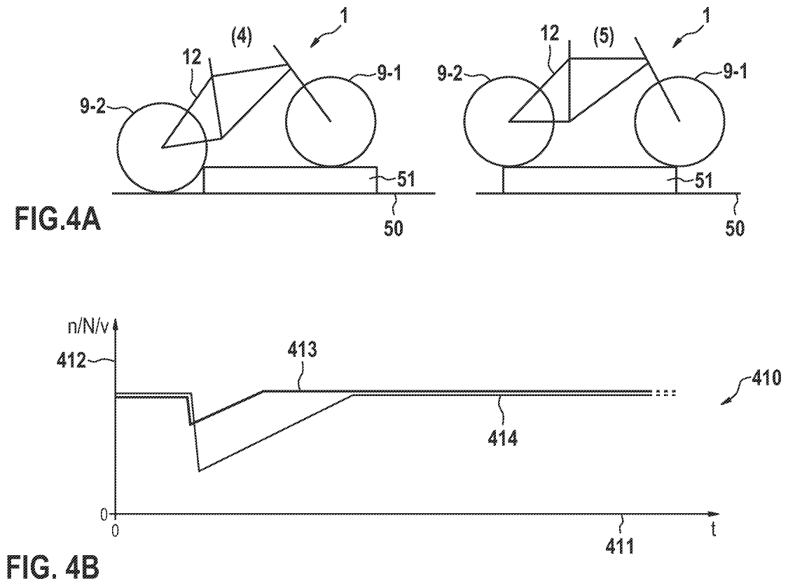

At y-axis 411 of graph 410, values of a motor speed n, a wheel speed N or a velocity v of vehicle 1 may be schematically plotted to illustrate with FIG. 4B how vehicle 1 has previously behaved according to track 414, and behaves according to the present invention according to track 413, at the obstacle.

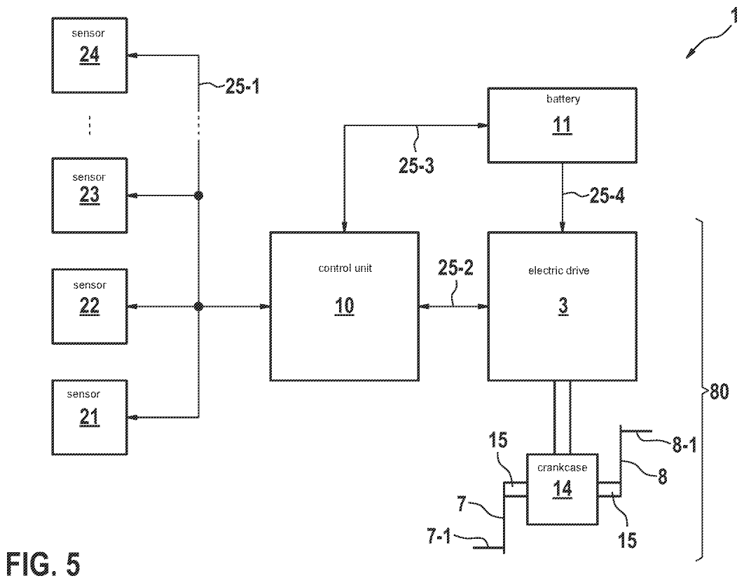

FIG. 5 shows a schematic illustration of another example of a vehicle 1 according to the present invention in the manner of an electric bicycle 1, with a focus on the implementation of the operating method according to the present invention.

In one specific embodiment of the present invention, the operative connection of sensors 21 through 24 of sensor system 20 to control unit 10 with the aid of control, supply and/or detection lines 25-1 is essential for this purpose.

Further control, supply and/or detection lines 25-2, 25-3 and 25-4 establish a corresponding operative connection between control unit 10 and motor drive 3, between control unit 10 and battery 11, and between battery 11 and motor drive 3.

These and further features and properties of the present invention are described hereafter based on the following explanations:

Conventionally, the control or regulation of the support by the motor drive in an electric bicycle and the like takes place based on measured values with respect to torque, rotational speed, velocity and/or uphill grade of the terrain.

According to the present invention, a specific regulation based on the presence of obstacles and/or based on how potential obstacles present on the driving route is now described.

On trail 50 or course 50, it may occur that a larger obstacle 51, for example in the form of a tree trunk, emerges. Usually, it is comparatively easy to set front wheel 9-1 down onto obstacle 51 or behind obstacle 51 with the aid of a pulling force Fz applied to the handle bar grip. Rear wheel 9-2, however, has to be primarily pushed over obstacle 51 with the aid of a motor and rider force.

If the force is not sufficient, it is possible to become stuck, drastically lose velocity and, in the worst case, lose balance.

This scenario, among others, is to be prevented by the present invention.

A core of the present invention is to recognize an obstacle 51 and to activate motor 3 or motor drive 3 of the vehicle in such a way that obstacle 51 may be easily overcome.

In the process, obstacle 51 may be recognized individually or in combination with the following situations and corresponding signals, for example with
(i) an (in particular, vertical) acceleration signal gz, which allows a raising or lift-off of front wheel 9-1 of vehicle 1 to be inferred;
(ii) a strong (in particular, vertical) pulling Fz on a grip of the handle bar of vehicle 1; and
(iii) a rapid change of the position of vehicle 1 from the plane or from the horizontal into an inclination or oblique position, i.e., deviating from the horizontal or from a previous position lasting for a certain time period, having a first angle of inclination, into a different position, having a second angle of inclination.

This is preferably recognized with the aid of the rotation rate detection. In the process, initially a deflection in the positive direction (front wheel goes up) and an almost equally large deflection in the negative direction (front wheel goes down) are recognized.

In the process, one or multiple of these situations and/or signals may be combined with one or with multiple of the following situations and, possibly, with the corresponding measured values, for example with:
(iv) a strong negative velocity gradient and/or rotational speed gradient at a rear wheel 9-2 of vehicle 1; and
(v) with one strong deflection or with multiple strong deflections in an inertial sensor system 23 of vehicle 1, both acceleration signals and rotation rate signals.

For a quantitative detection and representation, it is possible to use threshold values and/or time averaged signals. As soon as the rotation rate exceeds and then falls short of a first threshold value, this may be assessed with a strong deflection.

Initially, vehicle 1 or bicycle 1, for example, is generally undisturbed and on a course 50 or riding route 50, i.e., in state (1) in FIG. 2A.

If an obstacle 51, for example a curb or a tree trunk, must then be overcome, initially front wheel 9-1 must be lifted onto or over obstacle 51, as is described by state (2) in FIG. 2A.

This movement is to be detected. This may be detected by deflections at inertial sensor 23, which may have been or may be attached to or in an arbitrary location of vehicle 1 or bicycle 1, for example at the handle bar.

In contrast to a change in slope while riding off-road, a pulling up of the handle bar takes place much more quickly and more abruptly. Moreover, front wheel 9-1 setting down on or behind obstacle 51 is associated with a further deflection in the values of an inertial sensor system 23, as is shown in connection with state (3) from FIG. 2A.

Inertial sensor system 23 may be made up of an acceleration sensor and/or a rotation rate sensor or include such sensors.

As an alternative or in addition, force measurements at the handle bar or at the handle bar grip, which recognize strong pulling by the rider, are possible.

Various specific embodiments of the position recognition, such as, for example, LIDAR or radar, are also suitable for this situation.

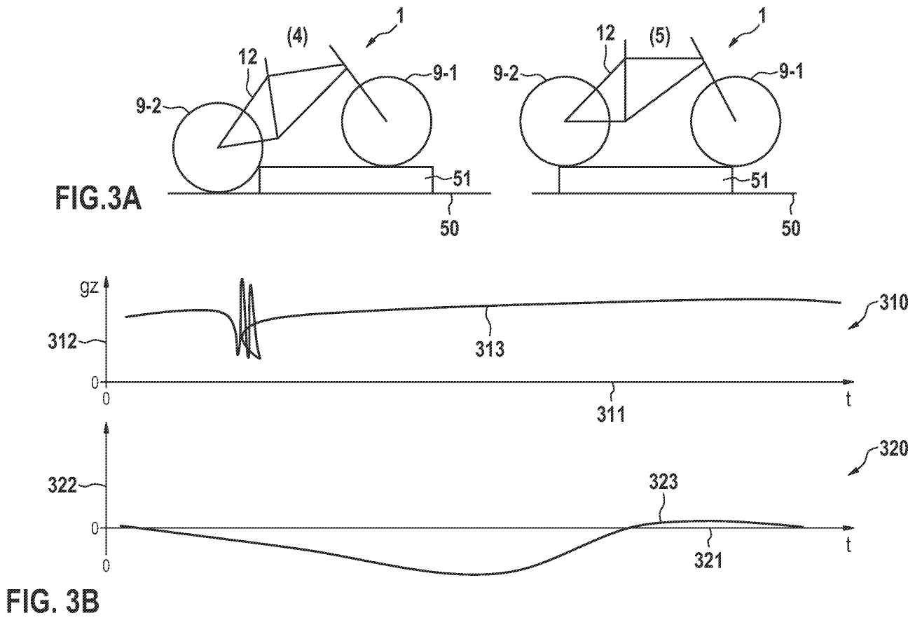

Another criterion is a subsequent drastic drop in the velocity at rear wheel 9-2 of vehicle 1 when it strikes against obstacle 51. This is described with state (4) in FIG. 3A.

This may take place either by a high-resolution velocity sensor system or a rotational speed sensor system, which may be coupled to rear wheel 9-2, for example via the drive train.

When these conditions are met, it is to be expected that obstacle 51 will appear at rear wheel 9-2 shortly and possibly strike it.

Motor 3 is activated as a function of the sensor values in such a way that obstacle 51 may be easily overcome, and state (5) from FIG. 3A is reached quickly and safely.

The activation may, for example individually or in any arbitrary combination, include as measures:
(a) an increase in the motor torque;
(b) an increase in the support factor or assistance factor, i.e., of the ratio of the motor torque to the rider torque;
(c) an extension of a time period of post-acceleration of motor 3 after a pedal stop, i.e., after pedaling has ended; and
(d) a definition of threshold values for a directly permissible velocity decrease and/or rotational speed decrease or their gradients.

In the process, e.g., an increase in the torque compared to the situation in front of an obstacle is crucial. This may, e.g., be measured as follows: In front of the obstacle, the motor torque is, e.g., 40 Nm, then there is the obstacle and the motor torque is increased to 60 Nm. The motor torque could also be increased via the permissible fatigue limit.

After the obstacle, e.g., after a certain time period, it is reduced to 40 Nm again. As an alternative, the support factor or assistance factor of 100% could be briefly increased to 200%. An extension of the post-acceleration time may, e.g., be designed in such a way that support continues to be provided for a path length by which the statutory limit of 2 m is approached.

With respect to measure (d), the activation may, for example, take place in such a way that the velocity and/or the rotational speed does or do not drop or collapse abruptly (e.g., strong, abrupt drop of the rotational speed) when rear wheel 9-2 hits an obstacle 51.

This is illustrated in connection with FIG. 4 and states (4) and (5) shown there.

The greater a recognized lift-off of front wheel 9-1 in state (2) and/or the change in position when reaching state (3), the stronger or greater can the described motor activations and/or measures of support by motor drive 3 be carried out.

The motor activation may be carried out temporally directly after state (2) and/or an obstacle 51 has/have been recognized to gain sufficient momentum for overcoming obstacle 51.

As an alternative, the adaptation of support or change of support may also only be activated when state (3) is reached, i.e., when front wheel 9-1 sets down again on or behind obstacle 51, or even only when state (4) is reached, i.e., when rear wheel 9-2 has reached obstacle 51, thus, in particular, at a point in time at which or as soon as the supporting torque is needed with pinpoint precision.

What is claimed is:

1. An operating method for a motor drive of a vehicle drivable by muscle power and additionally by motor power, the method comprising the following steps:
ascertaining whether and/or in what way an obstacle on a driving route of the vehicle is present directly at the vehicle;
conditionally adapting an operating state of the motor drive as a function of a result of the ascertainment; and
driving the vehicle using the motor drive in the adapted operating state.

2. The operating method as recited in claim 1, wherein the vehicle is an electric bicycle or an e-bike or a pedelec or an S-pedelec.

3. The operating method as recited in claim 1, wherein the presence of an obstacle is recognized during the ascertainment with respect to a potential obstacle based on:
(i) a raising or lift-off of a front wheel of the vehicle via an acceleration signal regarding a vertical acceleration, is detected; and/or
(ii) a strong pulling on a handle bar grip of the vehicle, is detected; and/or
(iii) a rapid change of the position of the vehicle from a position in a plane or horizontal into an oblique position, is detected; and/or
(iv) a deflection of a spring travel of a damper and/or a suspension fork, is detected; and/or
(v) a change in a tire pressure is detected; and/or
(vi) a change in a front wheel velocity when a front wheel hits an obstacle during the advance, is detected; and/or
(vii) a strong negative velocity gradient at a rear wheel via a rotational speed sensor at a rear wheel of the vehicle is detected; and/or
(viii) one or multiple hard deflections in an inertial sensor system is or are detected.

4. The operating method as recited in claim 1, wherein, during the conditional adaptation of the operating state of the motor drive:
(a) an increase in the motor torque takes place; and/or
(b) an increase in a support factor as a ratio of a torque of the motor drive to a torque of a rider introduced by muscle, takes place; and/or
(c) an extension of a time period of post-acceleration of the motor drive after pedaling by the rider has ended, takes place; and/or
(d) a definition of threshold values for a directly permissible velocity decrease and/or rotational speed decrease or their gradients, takes place.

5. The operating method as recited in claim 1, wherein an extension of a time period of a motor support takes place as a function of a position of a pedal, so that it is ensured that pedals of the vehicle do not become stuck at the obstacle.

6. The operating method as recited in claim 1, wherein the activation is adapted and set and takes place in such a way, during the conditional adaptation of the operating state of the motor drive, that a velocity of the vehicle and/or a rotational speed of a rear wheel of the vehicle do not drop abruptly when the rear wheel hits an obstacle.

7. The operating method as recited in claim 1, wherein, during the conditional adaptation of the operating state of the motor drive, an adapted activation of the motor drive and a support of the rider are configured to be greater the higher a detected raising or lift-off of a front wheel of the vehicle is and/or the greater a detected change in position of the vehicle is.

8. The operating method as recited in claim 1, wherein a driving of the vehicle using the motor drive in the adapted operating state takes place directly and/or temporally directly and/or without time delay after presence of an obstacle has been recognized.

9. The operating method as recited in claim 1, wherein:
a driving of the vehicle using the motor drive in the adapted operating state taking place with a time delay after presence of an obstacle has been recognized; and
the time delay, as a function of a velocity of the vehicle and/or of a rotational speed of a wheel of the vehicle, is set in such a way that: a front wheel of the vehicle sits on the obstacle and/or the front wheel of the vehicle has overcome the obstacle and/or a rear wheel of the vehicle has reached the obstacle.

10. A control unit for a motor drive of a vehicle drivable by muscle power and additionally by motor power, the control unit configured to:
ascertain whether and/or in what way an obstacle on a driving route of the vehicle is present directly at the vehicle;
conditionally adapt an operating state of the motor drive as a function of a result of the ascertainment; and
drive the vehicle using the motor drive in the adapted operating state.

11. The control unit as recited in claim 10, wherein the vehicle is an electric bicycle or an e-bike or a pedelec or an S-pedelec.

12. A vehicle drivable by muscle power and additionally by motor power, comprising:
at least one wheel;
a motor drive configured to drive the at least one wheel; and
a control unit for the motor drive, the control unit configured to:
ascertain whether and/or in what way an obstacle on a driving route of the vehicle is present directly at the vehicle,
conditionally adapt an operating state of the motor drive as a function of a result of the ascertainment, and
drive the vehicle using the motor drive in the adapted operating state.

13. The vehicle as recited in claim 12, wherein the vehicle is an electric bicycle or an e-bike or a pedelec or an S-pedelec.
